(19) United States
(12) Patent Application Publication
(10) Pub. No.: US 2026/0153192 A1
(43) Pub. Date: Jun. 4, 2026

(54) STATION FOR DISTRIBUTING A PRESSURIZED GAS AND METHOD FOR PREVENTING OR LIMITING ICING OF SUCH A STATION

(71) Applicant: L'Air Liquide, Societe Anonyme pour l'Etude et l’Exploitation des Procedes Georges Claude, Paris (FR)

(72) Inventors: Tom RONY, Paris (FR); Margo SIMON, Paris (FR)

(21) Appl. No.: 19/403,957

(22) Filed: Nov. 30, 2025

(30) Foreign Application Priority Data
Dec. 3, 2024 (FR) FR2413368

(51) Int. Cl. F17C 5/06; F17C 9/04

(52) U.S. Cl. CPC F17C 5/06; F17C 9/04; F17C 2227/0327

(57) ABSTRACT

Method for preventing or limiting icing of a station for distributing a pressurized gas, the station comprising a filling line having in series an end connected to a source of pressurized gas, a first heat exchanger for cooling a gas flow coming from the source, and a distribution terminal intended to distribute the cooled flow to a reservoir to be filled, the distribution station also comprising a bypass line of the filling line at the first heat exchanger, the method comprising a step of transferring a flow of relatively hot gas to the distribution terminal via the bypass line, the flow of relatively hot gas being at a temperature higher than a predefined temperature at the outlet of the first heat exchanger.

### CROSS REFERENCE TO RELATED APPLICATIONS

This application claims the benefit of priority under 35 U.S.C. § 119 (a) and (b) to French patent application No. FR2413368, filed Dec. 3, 2024, which is herein incorporated by reference in its entirety.

### FIELD OF THE INVENTION

The invention relates to a station for distributing a pressurized gas. The pressurized gas may be hydrogen. The invention also relates to a method for preventing or limiting icing of such a distribution station.

### BACKGROUND OF THE INVENTION

Hydrogen coming from a distribution station is generally pre-cooled down to a temperature range varying from −33° C. to −26° C. before transfer to a reservoir to be filled. This pre-cooling is carried out in order to prevent the effects of Joule-Thomson expansion on a terminal of the distribution station, and in particular on the pressure regulating valve situated at this terminal. Furthermore, this pre-cooling is carried out in order to limit the increase in the temperature of the hydrogen in the reservoir to be filled. The maximum temperature threshold not to be exceeded is generally fixed at 85° C.

When it is pre-cooled down to the temperature range indicated above, the hydrogen cools the distribution terminal, and brings about condensation followed by freezing of the moisture present in the ambient air. The presence of ice on the distribution terminal can be a source of discomfort for the user, in particular during removal of the distribution terminal from a receptacle of the reservoir to be filled.

In order to limit the formation of ice on the distribution terminal, a known method comprises a step of diffusing a flow of air or nitrogen over the distribution terminal. This solution therefore requires an air or nitrogen reservoir, which represents a certain cost and of which the integration into the distribution station poses a certain number of technical difficulties.

### SUMMARY OF THE INVENTION

An objective of certain embodiments of the present invention is to at least partially overcome the drawbacks listed above.

To this end, according to a first aspect, the invention proposes a method for preventing icing of a station for distributing a pressurized gas.

In particular, the distribution station comprises a filling line that has in series an end connected to a source of pressurized gas, a first heat exchanger for cooling the gas coming from the source, and a distribution terminal intended to provide a pre-cooled gas flow to a reservoir to be filled. The distribution station also comprises a bypass line of the filling line at the first heat exchanger.

According to this first aspect of the invention, the method comprises a step of transferring a flow of relatively hot gas to the distribution terminal via the bypass line. The flow of relatively hot gas is at a temperature higher than a predefined temperature at the outlet of the first heat exchanger.

The predefined temperature at the outlet of the first heat exchanger is that at which a pre-cooled gas flow is distributed to the reservoir to be filled at the outlet of the distribution terminal.

The flow of relatively hot gas sent to the distribution terminal heats the latter by conduction and makes it possible to prevent ice formation. When ice is already present on the terminal, the flow of relatively hot gas allows it to be eliminated.

Furthermore, embodiments of this first aspect of the invention may have one or more of the following features:
the flow of relatively hot gas transferred to the distribution terminal during the step of transfer via the bypass line is injected into the reservoir to be filled,
the step of transferring the flow of relatively hot gas to the distribution terminal via the bypass line occurs after a phase of distributing a pre-cooled gas flow into the reservoir to be filled,
the flow of relatively hot gas transferred to the distribution terminal during the step of transfer via the bypass line is not introduced into the reservoir to be filled,
the step of transferring the flow of relatively hot gas to the distribution terminal via the bypass line comprises an operation of controlling a flow rate of the flow of relatively hot gas towards the distribution terminal,
the operation of controlling the flow rate is executed with the aid of a control member disposed on the bypass line,
the temperature of the flow of relatively hot gas is obtained through the bypass line by Joule-Thomson expansion of the pressurized gas coming from the gas source,
the temperature of the flow of relatively hot gas is obtained through the bypass line with the aid of an active heating means, for example a second heat exchanger, disposed on the bypass line,
the method comprises a step of purging the flow of relatively hot gas via a purge line disposed in proximity to the distribution terminal,
the method comprises a step of controlling an increase in pressure of the gas at the distribution terminal.

According to a second aspect, the invention relates to a station for distributing a pressurized gas, such as hydrogen.

The station comprises a filling line having in series an end connected to a source of pressurized gas, a first heat exchanger for cooling a gas flow coming from the source, and a distribution terminal intended to distribute the cooled flow to a reservoir to be filled. Furthermore, the distribution station comprises a bypass line of the filling line at the first heat exchanger.

According to this second aspect of the invention, the station comprises an electronic member configured to control a transfer of a flow of relatively hot gas to the distribution terminal via the bypass line. The flow of relatively hot gas is at a temperature higher than a predefined temperature at the outlet of the first heat exchanger.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

Further particular features and advantages will become apparent upon reading the following description, which is provided with reference to the following figures, in which:

FIG. 1 is a schematic view illustrating a dispensing station for a pressurized gas according to the invention, the station comprising a filling line connecting a gas source, a heat exchanger and a dispenser, the station also comprising a bypass line on the filling line around the heat exchanger.

FIG. 2 illustrates steps of a method according to the invention for determining the initial pressure in a tank to be filled, from the dispensing station illustrated in FIG. 1.

### DETAILED DESCRIPTION OF THE INVENTION

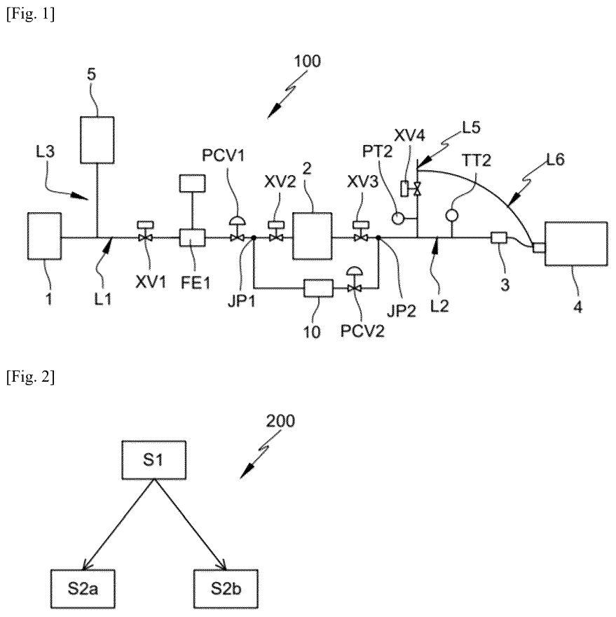

FIG. 1 illustrates a dispensing station 100 for a pressurized gas according to the invention.

The station 100 comprises a filling line and the following elements, connected in series by the filling line: a source 1 of pressurized gas, a first heat exchanger 2 configured to cool a gas flow coming from the gas source 1, and a distribution terminal 3 intended to provide the cooled gas flow to a reservoir 4 to be filled.

In particular, the filling line comprises a first circuit LI connecting the gas source 1 to an inlet of the first heat exchanger 2, and a second circuit L2 connecting an outlet of the first heat exchanger 2 to the distribution terminal 3.

The first circuit L1 is provided with a first valve XV1, a flowmeter FEI, a first pressure controller PCV1, and a second valve XV2.

The second circuit L2 is provided with a third valve XV3, a pressure sensor PT2 and a temperature sensor TT2.

The distribution station 100 may also comprise a storage reservoir 5 connected to the filling line via a third circuit L3. In particular, the third circuit L3 is connected to the first circuit L1 at a junction point situated upstream of the first valve XV1, of the flowmeter FE1, of the first pressure controller PCV1 and of the second valve XV2.

The distribution station 100 also comprises a bypass line L4 of the filling line at the first heat exchanger 2.

In particular, the bypass line L4 has a first end connected to the first circuit L1 at a first junction point JP1 situated upstream of the first heat exchanger 2. Furthermore, the bypass line L4 has a second end connected to the second circuit L2 at a second junction point JP2 situated downstream of the first heat exchanger 2.

It should be noted that the first valve XV1, the flowmeter FE1 and the first pressure controller PCV1 of the first circuit LI are disposed upstream of the first junction point JP1. The second valve XV2 of the first circuit LI is situated downstream of the first junction point JP1.

It should also be noted that the third valve XV3 of the second circuit L2 is disposed upstream of the second junction point JP2. The pressure sensor PT2 and the temperature sensor TT2 of the second circuit L2 are disposed downstream of the second junction point JP2.

Furthermore, the bypass line L4 comprises a system for heating the flow coming from the gas source 1 and/or from the storage reservoir 5.

This heating system may comprise a calibrated orifice (not illustrated) or a second pressure controller PCV2 that are each configured to expand a gas flow coming from the gas source 1 and/or the storage reservoir 5, and thus allow heating of this gas flow by Joule-Thomson expansion.

As a variant, or in addition, the heating system may comprise a second heat exchanger 10 configured to heat the gas flow actively, as opposed to the passive heating induced by the Joule-Thomson expansion.

Finally, the distribution station 100 may comprise a first purge line L5 connected to the filling line at the second circuit L2. The first purge line L5 is provided with a fourth valve XV4. In the example illustrated, the first purge line L5 bears the pressure sensor PT2.

To prevent or eliminate ice on the distribution terminal 3 of the station 100 described above, the invention introduces a method 200 described below.

The method 200 comprises a step S1 of transferring a flow of hot gas from the gas source 1 and/or from the storage reservoir 5 to the distribution terminal 3, passing via the bypass line L4. The flow of hot gas is at a temperature higher than a predefined temperature at which a cooled gas flow is distributed to the reservoir 4 to be filled at the outlet of the distribution terminal 3.

The step S1 of transferring the flow of hot gas to the distribution terminal 3 may result in the introduction of the hot gas flow into the reservoir 4 to be filled. This step S1 then occurs after a phase of distributing a pre-cooled gas flow to the reservoir 4. Such a transfer of hot gas flow into the reservoir 4 is allowed provided that the mixture with the pre-cooled gas already present in the reservoir 4 does not exceed the authorized maximum temperature.

The step S1 of transferring the flow of hot gas to the distribution terminal 3 may also take place without resulting in the introduction of this hot gas flow into the reservoir 4 to be filled.

In this case, the method 200 may comprise a step S2a of purging the flow of hot gas via a second purge line L6 disposed at the distribution terminal 3. Advantageously, the second purge line L6 may be connected to the first purge line L5.

In the absence of a second purge line L6 at the distribution terminal 3, the hot gas accumulated at the distribution terminal 3 may increase in pressure and present a risk to the integrity of this terminal 3. Thus, advantageously, the method 200 may comprise a step 2b of controlling an increase in pressure of the gas at the distribution terminal 3.

In all cases, the step S1 of transferring the hot gas flow to the distribution terminal 3 may comprise an operation of controlling a flow rate and/or a temperature of the hot gas flow. This control can be executed with the aid of a control member (not illustrated) configured to communicate with the second pressure controller PCV2 situated on the bypass line L4 and/or with the temperature sensor TT2 situated on the second circuit L2.

When the step SI of transferring the hot gas flow to the distribution terminal 3 results in the introduction of the hot gas flow into the reservoir 4 to be filled, the control member checks in particular that the temperature of the gas in the reservoir 4 to be filled does not exceed the fixed maximum threshold.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

We claim:

1. A method for preventing or limiting icing of a station for distributing a pressurized gas, the station comprising a filling line having, in series, an end connected to a source of pressurized gas, a first heat exchanger configured to cool a gas flow coming from the source, and a distribution terminal configured to distribute the cooled flow to a reservoir to be filled, the distribution station also comprising a bypass line of the filling line at the first heat exchanger, the method comprising the step of: transferring a flow of hot gas to the distribution terminal via the bypass line, the flow of hot gas being at a temperature higher than a predefined temperature at an outlet of the first heat exchanger.

2. The method as claimed in claim 1, wherein the flow of relatively hot gas transferred to the distribution terminal during step is injected into the reservoir to be filled.

3. The method as claimed in claim 1, wherein the step of transferring the flow of relatively hot gas occurs after a phase of distributing a pre-cooled gas flow into the reservoir to be filled.

4. The method as claimed in claim 1, wherein the flow of relatively hot gas transferred to the distribution terminal during step is not introduced into the reservoir to be filled.

5. The method as claimed in claim 1, wherein the step of transferring the flow of relatively hot gas comprises an operation of controlling a flow rate of the flow of relatively hot gas towards the distribution terminal.

6. The method as claimed in claim 1, wherein the operation of controlling the flow rate is executed with the aid of a control member disposed on the bypass line.

7. The method as claimed in claim 1, wherein the temperature of the flow of relatively hot gas is obtained through the bypass line by Joule-Thomson expansion of the pressurized gas coming from the gas source.

8. The method as claimed in claim 1, wherein the temperature of the flow of relatively hot gas is obtained through the bypass line with the aid of an active heating means, for example a second heat exchanger, disposed on the bypass line.

9. The method as claimed in claim 4, further comprising a step of purging the flow of relatively hot gas via a purge line disposed in proximity to the distribution terminal.

10. The method as claimed in claim 4, further comprising a step of controlling an increase in pressure of the gas at the distribution terminal.

11. A station configured to distribute a pressurized gas, the station comprising:
a filling line having, in series, an end connected to a source of pressurized gas;
a first heat exchanger configured to cool a gas flow coming from the source;
a distribution terminal intended to distribute the cooled flow to a reservoir to be filled, the distribution station also comprising a bypass line of the filling line at the first heat exchanger; and
an electronic member configured to control a transfer of a flow of relatively hot gas to the distribution terminal via the bypass line, the flow of relatively hot gas being at a temperature higher than a predefined temperature at the outlet of the first heat exchanger.
